(19) United States
(12) Patent Application Publication
(10) Pub. No.: US 2016/0307565 A1
(43) Pub. Date: Oct. 20, 2016

(54) DEEP NEURAL SUPPORT VECTOR MACHINES

(71) Applicant: MICROSOFT TECHNOLOGY LICENSING, LLC, Redmond, WA (US)

(72) Inventors: CHAOJUN LIU, Redmond, WA (US); KAISHENG YAO, REDMOND, WA (US); YIFAN GONG, SAMMAMISH, WA (US); SHIXIONG ZHANG, Beijing (CN)

(21) Appl. No.: 15/044,919

(22) Filed: Feb. 16, 2016

Related U.S. Application Data
(63) Continuation of application No. PCT/CN2015/076857, filed on Apr. 17, 2015.

(51) Int. Cl. G10L 15/16; G06N 3/02

(52) U.S. Cl. CPC G10L 15/16; G06N 3/02

(57) ABSTRACT

Aspects of the technology described herein relate to a new type of deep neural network (DNN). The new DNN is described herein as a deep neural support vector machine (DNSVM). Traditional DNNs use the multinomial logistic regression (softmax activation) at the top layer and underlying layers for training. The new DNN instead uses a support vector machine (SVM) as one or more layers, including the top layer. The technology described herein can use one of two training algorithms to train the DNSVM to learn parameters of SVM and DNN in the maximum-margin criteria. The first training method is a frame-level training. In the frame-level training, the new model is shown to be related to the multi-class SVM with DNN features. The second training method is the sequence-level training. The sequence-level training is related to the structured SVM with DNN features and HMM state transition features.

### CROSS-REFERENCE TO RELATED APPLICATIONS

This application is a continuation of International Application PCT/CN2015/076857, filed on Apr. 17, 2015, entitled “ Deep Neural Support Vector Machines,” the entirety of which is hereby incorporated by reference.

### BACKGROUND

Automatic speech recognition (ASR) can use language models for determining plausible word sequences for a given language or application domain. A deep neural network (DNN) can be used for speech recognition and image processing. The power of a DNN comes from its deep and wide network structure having a very large number of parameters. Yet, the performance of the DNN can be tied directly to the quality and quantity of the data used to train the DNN. The DNN systems can do a good job interpreting inputs similar to those in the training data, but can lack a robustness that allows the DNN to correctly interpret inputs that are not found within the training data, for example, when background noise is present.

### SUMMARY

This summary is provided to introduce a selection of concepts in a simplified form that are further described below in the detailed description. This summary is not intended to identify key features or essential features of the claimed subject matter, nor is it intended to be used in isolation as an aid in determining the scope of the claimed subject matter.

The technology described herein relates to a new type of deep neural network (DNN). The new DNN is described herein as a deep neural support vector machine (DNSVM). Traditional DNNs use the multinomial logistic regression (softmax activation) at the top layer and underlying layers for training. The new DNN instead uses a support vector machine (SVM) as one or more layers, including the top layer. The technology described herein can use one of two training algorithms to train the DNSVM to learn parameters of SVM and DNN in the maximum-margin criteria. The first training method is a frame-level training. In the frame-level training, the new model is shown to be related to the multiclass SVM with DNN features. The second training method is the sequence-level training. The sequence-level training is related to the structured SVM with DNN features and hidden Markov model (HMM) state transition features.

The DNSVM decoding process can use the DNN-HMM hybrid system but with frame-level posterior probabilities replaced by scores from the SVM.

The DNSVM improves the ASR system's performance, especially in terms of robustness, to provide an improved user experience. The improved robustness creates a more efficient user interface by allowing the ASR to correctly interpret a wider variety of user utterances.

### BRIEF DESCRIPTION OF THE DRAWINGS

Aspects of the technology are described in detail below with reference to the attached drawing figures, wherein:

FIG. 1 is a block diagram of an exemplary computing environment suitable for training a DNSVM, in accordance with an aspect of the technology described herein;

FIG. 2 is a diagram depicting an automatic speech recognition system, in accordance with an aspect of the technology described herein;

FIG. 3 is a diagram depicting a deep neural support vector machine, in accordance with an aspect of the technology described herein;

FIG. 4 is a flow chart depicting a method of training a DNSVM, in accordance with an aspect of the technology described herein; and

FIG. 5 is a block diagram of an exemplary computing environment suitable for implementing aspects of the technology described herein.

### DETAILED DESCRIPTION

The subject matter of the technology described herein is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Aspects of the technology described herein cover a new type of deep neural network that can be used to classify sounds, such as those within natural speech. The new model, which is described in detail subsequently, is termed a deep neural support vector machine (DNSVM) model herein. The DNSVM includes a support vector machine as at least one layer within a deep neural network architecture. The DNSVM model can be used as part of an acoustic model within an automatic speech recognition system. The acoustic model can be used with a language model and other components to recognize human speech. Very generally, the acoustic model classifies different sounds. The language model can use the output of the acoustic model as input to generate sequences of words.

Neural networks are universal models in the sense that they can effectively approximate non-linear functions on a compact interval. However, there are two major drawbacks of neural networks. First, the training usually requires the neural network to solve a highly non-linear optimization problem which has many local minima. Second, neural networks tend to overfit given the limited data if training goes on too long.

The support vector machine (SVM) has several prominent features. First, it has been shown that maximizing the margin is equivalent to minimizing an upper bound on the generalization error. Second, the optimization problem of SVM is convex, which is guaranteed to have a global optimal solution. The SVM was originally proposed for binary classification. It can be extended to handle the multi-class classification or sequence recognition using majority voting or by directly modifying the optimization. However, SVMs are in principle shallow architectures, whereas deep architectures with neural networks have been shown to achieve state-of-the-art performances in speech recognition. The technology described herein comprises a deep SVM architecture suitable for automatic speech recognition and other uses.

Traditional deep neural networks use the multinomial logistic regression (softmax active function) at the top layer for classification. The technology described herein replaces the logistic regression with an SVM. Two training algorithms are provided at frame- and sequence-level to learn the parameters of SVM and DNN in the maximum-margin criteria. In the frame-level training, the new model is shown to be related to the multi-class SVM with DNN features. In the sequence-level training, the new model is related to the structured SVM with DNN features and HMM state transition features. In the sequence case, the parameters of SVM, HMM state transitions, and language models can be jointly learned. Its decoding process can use the DNN-HMM hybrid system but with frame-level posterior probabilities replaced by scores from the SVM. The new model, which is described in detail subsequently, is termed a deep neural support vector machine (DNSVM) herein.

The DNSVM decoding process can use the DNN-HMM hybrid system but with frame-level posterior probabilities replaced by scores from the SVM.

The DNSVM improves the automatic speech recognition (ASR) system's performance, especially in terms of robustness, to provide an improved user experience. The improved robustness creates a more efficient user interface by allowing the ASR to correctly interpret a wider variety of user utterances.

### Computing Environment

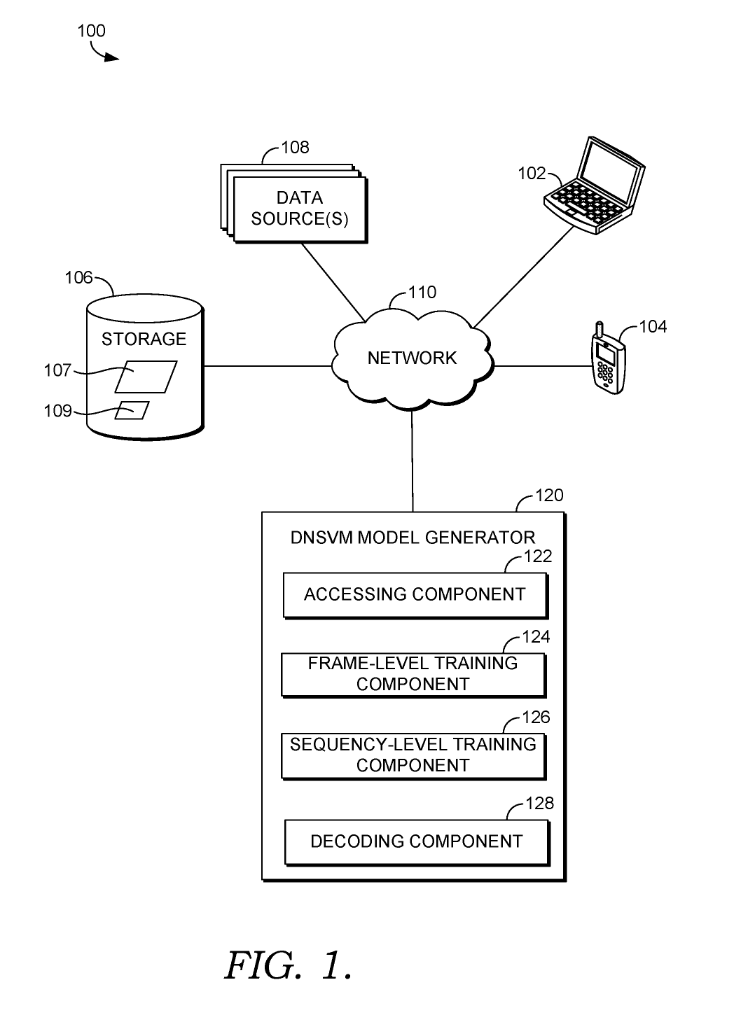

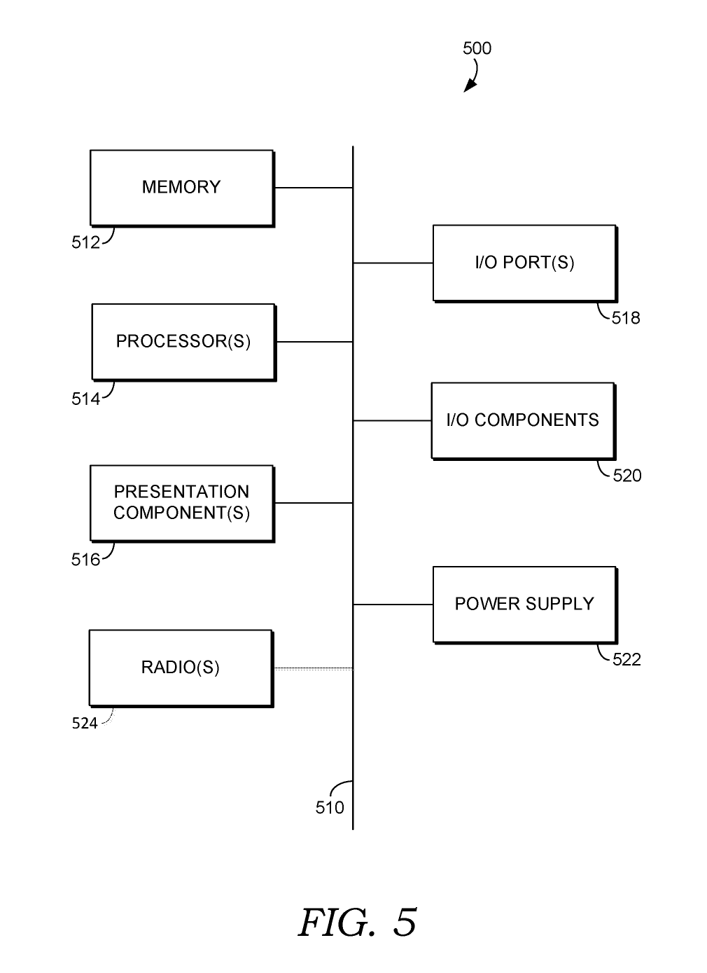

Among other components not shown, system 100 includes network 110 communicatively coupled to one or more data source(s) 108, storage 106, user devices 102 and 104, and DNSVM model generator 120. The components shown in FIG. 1 may be implemented on or using one or more computing devices, such as computing device 500 described in connection to FIG. 5. Network 110 may include, without limitation, one or more local area networks (LANs) and/or wide area networks (WANs). Such networking environments are commonplace in offices, enterprise-wide computer networks, intranets, and the Internet. It should be understood that any number of data sources, storage components or data stores, user devices, and DNSVM model generators may be employed within the system 100 within the scope of the technology described herein. Each may comprise a single device or multiple devices cooperating in a distributed environment. For instance, the DNSVM model generator 120 may be provided via multiple computing devices or components arranged in a distributed environment that collectively provide the functionality described herein. Additionally, other components not shown may also be included within the network environment.

Example system 100 includes one or more data source(s) 108. Data source(s) 108 comprise data resources for training the DNSVM models described herein. The data provided by data source(s) 108 may include labeled and un-labeled data, such as transcribed and un-transcribed data. For example, in an embodiment, the data includes one or more phone sets (sounds) and may also include corresponding transcription information or senone labels that may be used for initializing the DNSVM model. In an embodiment, the un-labeled data in data source(s) 108 is provided by one or more deployment-feedback loops. For example, usage data from spoken search queries performed on search engines may be provided as un-transcribed data. Other examples of data sources may include by way of example, and not limitation, various spoken-language audio or image sources including streaming sounds or video, web queries, mobile device camera or audio information, web cam feeds, smart-glasses and smart-watch feeds, customer care systems, security camera feeds, web documents, catalogs, user feeds, SMS logs, instant messaging logs, spoken-word transcripts, gaming system user interactions such as voice commands or captured images (e.g., depth camera images), tweets, chat or video-call records, or social-networking media. Specific data source(s) 108 used may be determined based on the application including whether the data is domain-specific data (e.g., data only related to entertainment systems, for example) or general (non-domain-specific) in nature.

Example system 100 includes user devices 102 and 104, which may comprise any type of computing device where it is desirable to have an ASR system on the device. For example, in one embodiment, user devices 102 and 104 may be one type of computing device described in relation to FIG. 5 herein. By way of example and not limitation, a user device may be embodied as a personal data assistant (PDA), a mobile device, smartphone, smart watch, smart glasses (or other wearable smart device), augmented reality headset, virtual reality headset, a laptop, a tablet, remote control, entertainment system, vehicle computer system, embedded system controller, appliance, home computer system, security system, consumer electronic device, or other similar electronics device. In one embodiment, the user device is capable of receiving input data such as audio and image information usable by an ASR system described herein that is operating in the device. For example, the user device may have a microphone or line-in for receiving audio information, a camera for receiving video or image information, or a communication component (e.g., Wi-Fi functionality) for receiving such information from another source, such as the Internet or a data source 108.

The ASR model using a DNSVM model described herein can process the inputted data to determine computer-usable information. For example, a query spoken by a user may be processed to determine the content of the query (i.e., what the user is asking for).

Example user devices 102 and 104 are included in system 100 to provide an example environment wherein the DNSVM model may be deployed. Although, it is contemplated that aspects of the DNSVM model described herein may operate on one or more user devices 102 and 104, it is also contemplated that some embodiments of the technology described herein do not include user devices. For example, a DNSVM model may be embodied on a server or in the cloud. Further, although FIG. 1 shows two example user devices, more or fewer devices may be used.

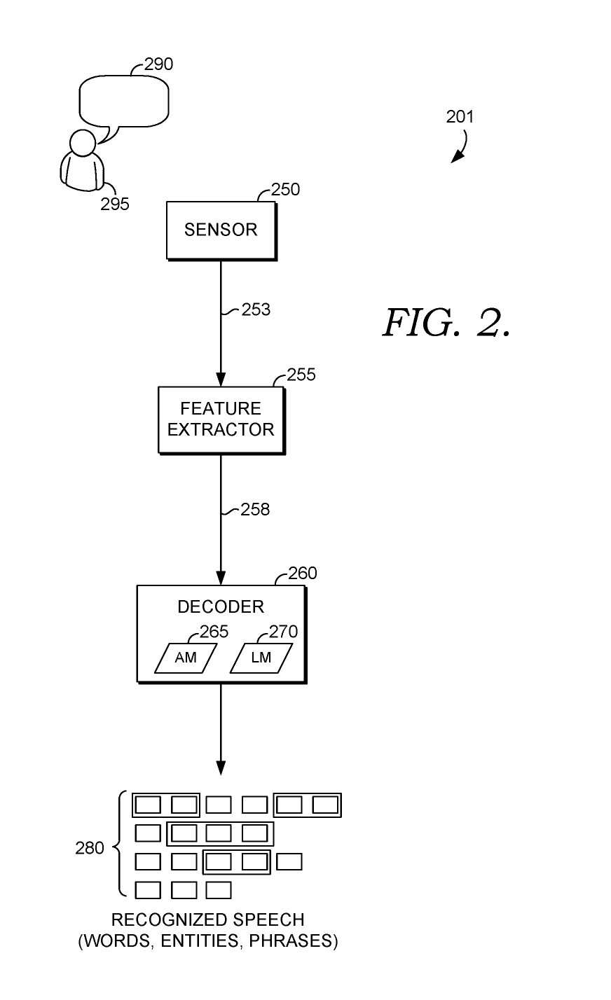

Storage 106 generally stores information including data, computer instructions (e.g., software program instructions, routines, or services), and/or models used in embodiments of the technology described herein. In an embodiment, storage 106 stores data from one or more data source(s) 108, one or more DNSVM models, information for generating and training DNSVM models, and the computer-usable information outputted by one or more DNSVM models. As shown in FIG. 1, storage 106 includes DNSVM models 107 and 109. Additional details and examples of DNSVM models are described in connection to FIGS. 2-5. Although depicted as a single data store component for the sake of clarity, storage 106 may be embodied as one or more information stores, including memory on user device 102 or 104, DNSVM model generator 120, or in the cloud.

DNSVM model generator 120 comprises an accessing component 122, a frame-level training component 124, a sequence-level training component 126, and a decoding component 128. The DNSVM model generator 120, in general, is responsible for generating DNSVM models, including creating new DNSVM models (or adapting existing DNSVM models). The DNSVM models generated by generator 120 may be deployed on a user device such as device 104 or 102, a server, or other computer system. DNSVM model generator 120 and its components 122, 124, 126, and 128 may be embodied as a set of compiled computer instructions or functions, program modules, computer software services, or an arrangement of processes carried out on one or more computer systems, such as computing device 500, described in connection to FIG. 5, for example. DNSVM model generator 120, components 122, 124, 126, and 128, functions performed by these components, or services carried out by these components may be implemented at appropriate abstraction layer(s) such as the operating system layer, application layer, hardware layer, etc., of the computing system(s). Alternatively, or in addition, the functionality of these components, generator 120, and/or the embodiments of technology described herein can be performed, at least in part, by one or more hardware logic components. For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc.

Continuing with FIG. 1, accessing component 122 is generally responsible for accessing and providing to DNSVM model generator 120 training data from one or more data sources 108. In some embodiments, accessing component 122 may access information about a particular user device 102 or 104, such as information regarding the computational and/or storage resources available on the user device. In some embodiments, this information may be used to determine the optimal size of a DNSVM model generated by DNSVM model generator 120 for deployment on the particular user device.

The frame-level training component 124 uses a frame-level training method of training a DNSVM model. In some embodiments of the technology described herein, the DNSVM model inherits a model structure, including the phone set, a hidden Markov model (HMM) topology, and tying of context-dependent states, directly from a context-dependent, Gaussian mixture model, hidden Markov model (CD-GMM-HMM) system, which may be predetermined. Further, in an embodiment, the senone labels used for training the DNNs may be extracted from the forced alignment generated using the DNSVM model. In some embodiments, a training criterion is to minimize cross entropy which is reduced to minimize the negative log likelihood because every frame has only one target label sₜ:

−Σₜ log(P(sₜ|xₜ)) (1)

The DNN model parameters may be optimized with back propagation using stochastic gradient descent or a similar technique known to one of ordinary skill in the art.

Currently, most of the DNNs use the multinomial logistic regression, also known as softmax active function, at the top layer for classification. Specifically, given the observation σₜ at frame t, let hₜ equal the output vector of the top hidden layer in DNNs, the output of DNNs for state sₜ can be expressed as

$$P ( {S}_{t} \vert {O}_{t} ) = \frac{exp ( {w}_{{s}_{t}}^{T} {h}_{t} )}{{\sum }_{{s}_{t} = 1}^{N} exp ( {w}_{{s}_{t}}^{T} {h}_{t} )} \qquad ( 2 )$$

where wₛₜ are the weights connecting the last hidden layer to the output state sₜ, and N is the number of states. Note the normalization term in equation (2) is independent of states, thus, it can be ignored during frame classification or sequence decoding. For example, in the frame classification, given an observation oₜ, the corresponding state sₜ can be inferred by:

arg maxₛ log P(s|oₜ)=arg maxₛ log wₛ_{ₜ}^{T}hₜ (3)

For multiclass SVM, the classification function is:

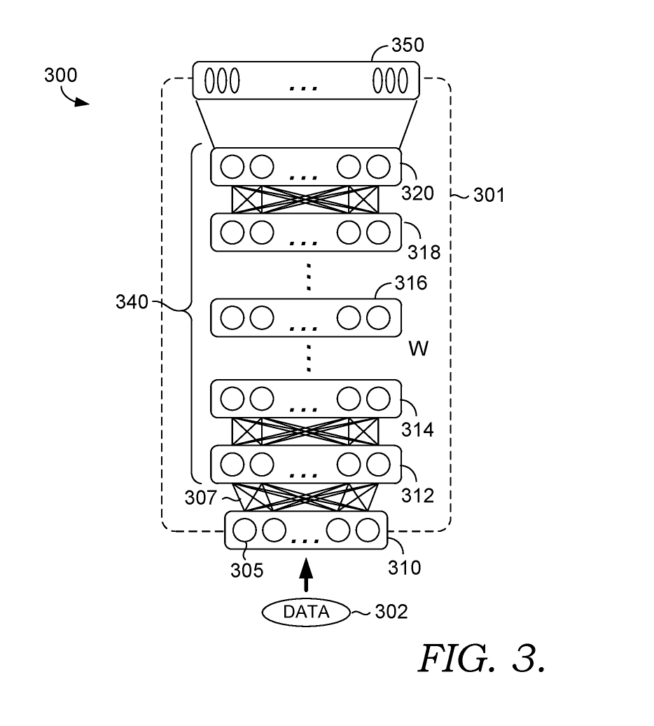

arg max wₛ^{T}φ(oₜ) (4)

where φ(oₜ) is the predefined feature space and wₛ is the weight parameter for class/state s. If DNNs are used to derive the feature space, e.g., φ(oₜ(oₛ) [symbol] hₜ, decoding of multiclass SVMs and DNNs are the same. Note that DNNs can be trained using the frame-level cross-entropy (CE) or sequence-level maximum mutual information/ state-level minimum Bayes risk MMI/sMBR criteria. The technology described herein can use algorithms at either frame- or sequence-level to estimate the parameters of SVM (in a layer) and to update the parameters of DNN (in all previous layers) using maximum-margin criteria. The resulting model is named deep neural SVM (DNSVM). Its architecture is illustrated in FIG. 3.

Turning now to FIG. 3, aspects of an illustrative representation of a DNSVM model classifier are provided and referred to generally as DNSVM model classifier 300. This example DNSVM model classifier 300 includes a DNSVM model 301. (FIG. 3 also shows data 302, which is shown for purposes of understanding, but which is not considered a part of classifier 300.) In one embodiment, DNSVM model 301 comprises a model and may be embodied as a specific structure of mapped probabilistic relationships of an input onto a set of appropriate outputs, such as illustratively depicted in FIG. 3. The probabilistic relationships (shown as connected lines 307 between the nodes 305 of each layer) may be determined through training. Thus, in some embodiments of the technology described herein, the DNSVM model 301 is defined according to its training. (An untrained DNN model therefore may be considered to have a different internal structure than the same DNN model that has been trained.) A deep neural network (DNN) can be considered as a conventional multi-layer perceptron (MLP) with many hidden layers (thus deep).

The DNSVM model comprises multiple layers 340 of nodes. The nodes may also be described as perceptrons. The acoustic inputs or features fed into the classifier can be shown as an input layer 310. A line 307 connects each node in the input layer 310 to each node in the first hidden layer 312 within the DNSVM model. Each node in the hidden layer 312 performs a calculation to generate an output that is then fed into each node in the second hidden layer 314. The different nodes may give different weight to different inputs resulting in a different output. The weights and other factors unique to each node that are used to perform a calculation to produce an output are described herein as “node parameters” or just “parameters.” The node parameters are learned through training. Nodes in second hidden layer 314 pass results to nodes in layer 316. Nodes in layer 316 communicate results to nodes in layer 318. Nodes in layer 318 pass calculation results to top layer 320, which produces final results shown as an output layer 350. The output layer is shown with multiple nodes but could have as few as a single node. For example, the output layer could output a single classification for an acoustic input. In the DNSVM model, one or more of the layers is a support vector machine. Different types of support vector machines may be used, for example, a structured support vector machine or a multiclass SVM.

### Frame-Level Maximum-Margin Training

Returning to FIG. 1, the frame-level training component 124 assigns parameters to nodes within a DMSVM using frame-level training. The frame-level training can be used when a multi-class SVM is used for one or more layers in the DNSVM model. Given the training observations and their corresponding state labels {(oₜ, sₜ)}ₜ₌^{T}, where s_{t ∈{}1, . . . N}, in frame-level training, the parameters of DNNs can be estimated by minimizing the cross-entropy. Herein, let φ(oₜ) [symbol] hₜ as the feature space derived from the DNN, the parameters of the last layer are first estimated using the multi-class SVM training algorithm:

$${min}_{{w}_{s} , {ɛ}_{t}} \frac{1}{2} {\sum }_{s = 1}^{N} {‖ {w}_{s} ‖}_{2}^{2} + C {\sum }_{t = 1}^{T} {ɛ}_{t} \qquad ( 5 )$$

s.t. for every training frame t=1, . . . , T,
for every competing state s̅_{t ∈{}1, . . . , N}:

wₛ_{ₜ}^{T}hₜ−w_{s̅}_{ₜ}^{T}hₜ≦1−εₜ, s̅ₜ≠sₜ (6)

where εₜ≦0 is the slack variable which penalizes the data points that violate the margin requirement. Note that the objective function is essentially the same as the binary SVM. The only difference comes from the constraints, which basically say that the score of the correct state label, wₛ_{ₜ}^{T}hₜ, has to be greater than the scores of any other states, w_{s̅}_{ₜ}^{T}hₜ, by a margin determined by the loss. In equation (5), the loss is a constant 1 for any misclassification. Using the squared slacks can be slightly better than εₜ, thus εₜ² is applied in equation (5).

Note if the correct score, wₛ_{ₜ}^{T}hₜ, is greater than all the competing scores, w_{s̅}_{ₜ}^{T}hₜ, it must be greater than the “most” competing score, max_{s̅}_{ₜ}_{≠s}_{ₜ}hₜ w_{s̅}_{ₜ}^{T}hₜ. Thus, substituting the slack variable εₜ from the constraints into the objective function, equation (5) can be reformulated as the minimization of:

$${ℱ}_{fMM} ( w ) = \frac{1}{2} {‖ {w}_{s} ‖}_{2}^{2} + C {\sum }_{t = 1}^{T} {[ 1 - {w}_{{s}_{t}}^{T} {h}_{t} + {max}_{\overline{{s}_{t}} \neq {s}_{t}} {w}_{\overline{{s}_{t}}}^{T} {h}_{t} ]}_{+}^{2} \qquad ( 7 )$$

where w=[w₁^{T}, . . . , w_{N}^{T}]^{T} are the parameter vectors for each state and [·]₊ is the hinge function. Note the maximum of a set of linear functions is convex, thus equation (7) is convex with respect to w.

Given the multi-class SVM parameters w, the parameters of the previous layer w^{[II]} can be updated by back propagating the gradients from the top layer multi-class SVM:

$$\frac{\partial {ℱ}_{fMM}}{\partial {w}_{i}^{[ l ]}} = {\sum }_{t = 1}^{T} ( \frac{\partial {ℱ}_{fMM}^{T}}{\partial {h}_{t}} \frac{\partial {h}_{t}}{\partial {w}_{i}^{[ l ]}} ) \qquad ( 8 )$$

### Note

$$\frac{\partial {h}_{t}}{\partial {w}_{i}^{[ l ]}}$$

is the same as standard DNNs. The key is to compute the derivative of F_{fMM} with respect to the activations, hₜ. However, equation (7) is not differentiable because of the hinge function and max(.). To handle this, the subgradient method is applied. Given the current multi-class SVM parameters (in the last layer) for each state, wₛ, and the most competing state label s̅ₜ=arg maxₛ_{ₜ} w_{S}^{T}hₜ, the subgradient of objective function (7) can be expressed as:

$$\frac{\partial {ℱ}_{fMM}}{\partial {h}_{t}} = 2 {C [ 1 + {w}_{\overline{{s}_{t}}}^{T} {h}_{t} - {w}_{{s}_{t}}^{T} {h}_{t} ]}_{+} ( {w}_{\overline{{s}_{t}}} - {w}_{{s}_{t}} ) \qquad ( 9 )$$

After this point, the back propagation algorithm is exactly the same as the standard DNNs. Note that, after training of multi-class SVMs, most of the training frames can be classified correctly and beyond the margin. This means, for those frames, wₛ_{ₜ}^{T}hₜ>w_{s̅}_{ₜ}^{T}hₜ+1. Thus, only the rest few training samples (support vectors) have non-zero subgradients.

### Sequence-Level Maximum-Margin Training

The sequence-level training component 126 trains a DNSVM using a sequence-level maximum-margin training method. The sequence-level training can be used when a structured SVM is used for one or more layers. The sequence-level trained DNSVM can act like an acoustic model and a language model. In the maximum-margin sequence training, for simplicity, first consider one training utterance (O, S), where O={o₁, . . . , o_{T}} is the observation sequence and S={s₁, . . . , s_{T}} is the corresponding reference states. The parameters of the model can be estimated by maximizing:

$${min}_{\overline{s} \neq s} \{ log \frac{P ( S \vert O )}{P ( \overline{S} \vert O )} \} = {min}_{\overline{s} \neq s} \{ log \frac{p ( O \vert S ) P ( S )}{p ( O \vert \overline{S} ) P ( \overline{S} )} \} \qquad ( 10 )$$

Here the margin is defined as the minimum distance between the reference state sequence S and competing state sequence S̅ in the log posterior domain. Note that, unlike MMI/sMBR sequence training, the normalization term Σₛp(O,S) in posterior probability is cancelled out, as it appears in both the numerator and denominator. For clarity, the language model probability is not shown here. To generalize the above objective function, a loss function £(S, S̅) is introduced to control the size of the margin, a hinge function [·]₊ is applied to ignore the data that is beyond the margin, and a prior P(w) is incorporated to further reduce the generalization error. Thus, the criterion becomes minimizing:

$$- log P ( w ) + {[ {max}_{\overline{S} \neq S} \{ ℒ ( S , \overline{S} ) - log \frac{p ( O \vert S ) P ( S )}{p ( O \vert \overline{S} ) P ( \overline{S} )} \} ]}_{+}^{2} \qquad ( 11 )$$

For DNSVM, the log (p(O|S)P(S)) can be computed via:

$${\sum }_{t = 1}^{T} ( {w}_{St}^{T} {h}_{t} - log P ( {s}_{t} ) + log P ( {s}_{t} \vert {s}_{t - 1} ) ) = {w}^{T} φ ( O , S ) \qquad ( 12 )$$

where φ(O, S) is the points feature, which characterizes the dependencies between O and S:

$$φ ( O , S ) = {\sum }_{t = 1}^{T} [ \begin{matrix}δ ( {s}_{t} = 1 ) {h}_{t} \\ ⋮ \\ δ ( {s}_{t} = N ) {h}_{t} \\ log P ( {s}_{t} ) \\ log P ( {s}_{t} \vert {s}_{t - 1} )\end{matrix} ] , \\ w = [ \begin{matrix}{w}_{1} \\ ⋮ \\ {w}_{N} \\ - 1 \\ + 1\end{matrix} ] \qquad ( 13 )$$

where δ(·) is the Kronecker delta (indicator) function. Here the prior, P(w), is assumed to be a Gaussian with a zero mean and a scaled identity covariance matrix CI, thus log

$$P ( w ) = log N ( 0 , CI ) ∞ - \frac{1}{2 C} {w}^{T} w .$$

Substituting the prior and equation (12) into criterion (11), the parameters of DNSVM (in the last layer) can be estimated by minimizing:

$${ℱ}_{sMM} ( w ) = \frac{1}{2} {‖ w ‖}_{2}^{2} + C {\sum }_{u = 1}^{U} [ \overbrace{- {w}^{T} φ ( {O}_{u} , {S}_{u} )}^{linear} + {\underbrace{{max}_{{\overline{S}}_{u} \neq {S}_{u}} \{ ℒ ( {S}_{u} , {\overline{S}}_{u} ) + {w}^{T} φ ( {O}_{u} , {\overline{S}}_{u} ) \} ]}_{convex}}_{+}^{2} \qquad ( 14 )$$

where u=1, . . . , U is the index of training utterances. Like the F_{fMM}, F_{sMM} is also convex for w. Interestingly, equation (14) is the same as the training criterion for structured SVMs. It can be solved using the cutting plane algorithm Solving the optimization (14) requires the search of the most competing state sequence S̅ᵤ efficiently. If the state-level loss is applied, the search problem, maxSᵤ{·}, can be solved using the Viterbi decoding algorithm The computational load during training can be dominated by this search process. In one aspect, up to U parallel threads, each searching the S̅ᵤ for a subset of training data, could be used. A central server can be used to collect S̅ᵤ from each thread and then update the parameters.

To speed up the training, denominator lattices with state alignments are used to constrain the searching space. Then a lattice-based forward-backward search is applied to find the most competing state sequence S̅ᵤ.

Similar to the frame-level case, the parameters of previous layers can also be updated by back propagating the gradients from the top layer. The top layer parameters are fixed during this process while the parameters of the previous layers are updated. Equation 15 can be used to calculate the subgradient of F_{sMM} with respect to hₜ for utterance u and frame t:

$$\frac{\partial {ℱ}_{sMM}}{\partial {h}_{t}} = 2 {C [ ℒ + {w}^{T} \overline{φ} - {w}^{T} φ ]}_{+} ( {w}_{{\overline{s}}_{t}} - {w}_{{s}_{t}} ) \qquad ( 15 )$$

where £ is the loss between the reference Sᵤ and its most competing state sequence S̅ᵤ, and φ is short for φ(Oᵤ, S̅ᵤ). After this point, the back propagation algorithm is exactly the same as the standard DNNs.

When the hidden layers are SVMs instead of neural networks, the width of the network (the number of nodes in each hidden layer) can be automatically learned by the SVM training algorithm, instead of designated an arbitrary number. More specifically, if the outputs of the last layer are used as an input feature for SVM in a current layer, the support vectors detected by the SVM algorithm can be used to construct a node in the current layer. So the more support vectors detected (which means the data is hard to classify), the wider the layer will be constructed.

### Decoding

The decoding component 128 applies the trained DNSVM model to categorize audio data into identify senones within the audio data. The results can then be compared to the categorization data to measure accuracy. The decoding process used to validate the training can also be used on uncategorized data to generate results used to categorize un-labeled speech. The decoding process is similar to the standard DNN-HMM hybrid system but with posterior probabilities, log P(sₜ|oₜ) replaced by the scores from DNSVM, wₛ_{ₜ}^{T}hₜ. If the sequence training is applied, the state priors, state transition probabilities (in log domain), and language model scores are also scaled by the weights learned from equation (14). Note that decoding the most likely state sequence S is essentially the same as inferring the most competing state sequence S̅ᵤ in equation (14), except for the loss £(Sᵤ, S̅ᵤ). They can be solved using the Viterbi algorithm.

### Automatic Speech Recognition System Using DNSVM

Turning now to FIG. 2, an example of an automatic speech recognition (ASR) system is shown according to an embodiment of the technology described herein. The ASR system 201 shown in FIG. 2 is just one example of an ASR system that is suitable for use with a DNSVM for determining recognized speech. It is contemplated that other variations of ASR systems may be used including ASR systems that include fewer components than the example ASR system shown here, or additional components not shown in FIG. 2.

The ASR system 201 shows a sensor 250 that senses acoustic information (audibly spoken words or speech 290) provided by a user-speaker 295. Sensor 250 may comprise one or more microphones or acoustic sensors, which may be embodied on a user device (such as user devices 102 or 104, described in FIG. 1). Sensor 250 converts the speech 290 into acoustic signal information 253 that may be provided to a feature extractor 255 (or may be provided directly to decoder 260, in some embodiments). In some embodiments, the acoustic signal may undergo preprocessing (not shown) before feature extractor 255. Feature extractor 255 generally performs feature analysis to determine the parameterized useful features of the speech signal while reducing noise corruption or otherwise discarding redundant or unwanted information. Feature extractor 255 transforms the acoustic signal into a features 258 (which may comprise a speech corpus) appropriate for the models used by decoder 260.

Decoder 260 comprises an acoustic model (AM) 265 and a language model (LM) 270. AM 265 comprises statistical representations of distinct sounds that make up a word, which may be assigned a label called a “phenome.” The AM 265 can use a DNSVM to assign the labels to sounds. AM 265 can model the phenomes based on the speech features and provides to LM 270 a corpus comprising a sequence of words corresponding to the speech corpus. As an alternative, the AM 265 can provide a string of phenomes to the LM 270. LM 270 receives the corpus of words and determines a recognized speech 280, which may comprise words, entities (classes), or phrases.

In some embodiments, the LM 270 may reflect specific subdomains or certain types of corpora, such as certain classes (e.g., personal names, locations, dates/times, movies, games, etc.), words or dictionaries, phrases, or combinations of these, such as token-based component LMs.

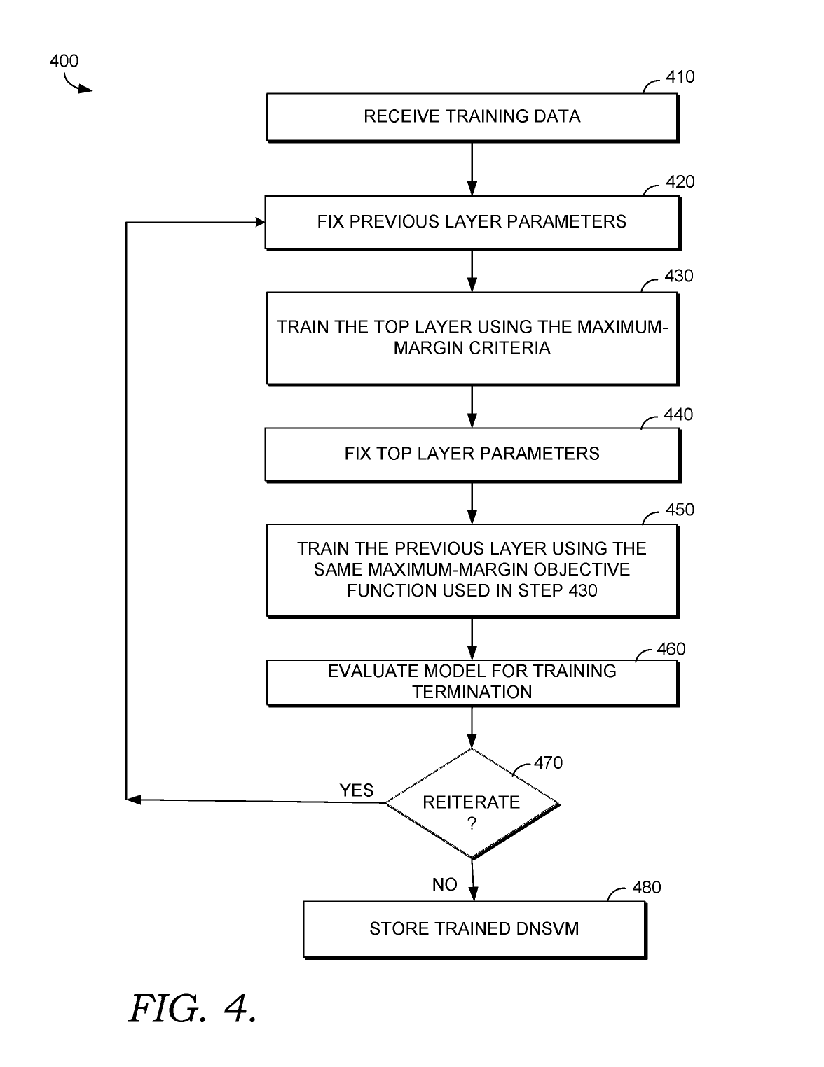

Turning now to FIG. 4, a method 400 for training a deep neural support vector machine (DNSVM) performed by one or more computing devices having a processor and a memory is described. The method comprises receiving a corpus of training material at step 410. The corpus of training material can comprise one or more labeled acoustic features. At step 420, initial values for parameters of one or more previous layers within the DNSVM are determined and fixed. At step 430, a top layer of the DNSVM is trained while keeping the initial values fixed using a maximum-margin objective function to find a solution. The top layer can be a support vector machine. The top layer could be multi-class, structured, or another type of support vector machine.

At step 440, initial values are assigned to the top layer parameters according to the solution and fixed. At step 450, the previous layers of the DNSVM are trained while keeping the initial values of the top layer parameters fixed. The training uses the maximum-margin objective function of step 430 to generate updated values for parameters of the one or more previous layers. The training of the previous layers may also use a subgradient decent calculation. At step 460, the model is evaluated for termination. In one aspect, steps 420-450 are repeated iteratively 470 to retrain the top layer and the previous layers until parameters change less than a threshold between iterations. When the parameters change less than the threshold, then the training stops and the DNSVM model is saved at step 480.

Training the top layer at step 430 and/or training the previous layers at step 450 could use either the frame-level training or the sequence-level training described previously.

### Exemplary Operating Environment

Referring to the drawings in general, and initially to FIG. 5 in particular, an exemplary operating environment for implementing aspects of the technology described herein is shown and designated generally as computing device 500. Computing device 500 is but one example of a suitable computing environment and is not intended to suggest any limitation as to the scope of use or functionality of the technology described herein. Neither should the computing device 500 be interpreted as having any dependency or requirement relating to any one or combination of components illustrated.

The technology described herein may be described in the general context of computer code or machine-useable instructions, including computer-executable instructions such as program components, being executed by a computer or other machine, such as a personal data assistant or other handheld device. Generally, program components, including routines, programs, objects, components, data structures, and the like, refer to code that performs particular tasks or implements particular abstract data types. Aspects of the technology described herein may be practiced in a variety of system configurations, including handheld devices, consumer electronics, general-purpose computers, specialty computing devices, etc. Aspects of the technology described herein may also be practiced in distributed computing environments where tasks are performed by remote-processing devices that are linked through a communications network.

With continued reference to FIG. 5, computing device 500 includes a bus 510 that directly or indirectly couples the following devices: memory 512, one or more processors 514, one or more presentation components 516, input/output (I/O) ports 518, I/O components 520, and an illustrative power supply 522. Bus 510 represents what may be one or more busses (such as an address bus, data bus, or combination thereof). Although the various blocks of FIG. 5 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. The inventors hereof recognize that such is the nature of the art, and reiterate that the diagram of FIG. 5 is merely illustrative of an exemplary computing device that can be used in connection with one or more aspects of the technology described herein. Distinction is not made between such categories as “workstation,” “server,” “laptop,” “handheld device,” etc., as all are contemplated within the scope of FIG. 5 and refer to “computer” or “computing device.”

Computing device 500 typically includes a variety of computer-readable media. Computer-readable media can be any available media that can be accessed by computing device 500 and includes both volatile and nonvolatile media, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules, or other data.

Computer storage media includes RAM, ROM, EEPROM, flash memory or other memory technology, CD-ROM, digital versatile disks (DVD) or other optical disk storage, magnetic cassettes, magnetic tape, magnetic disk storage or other magnetic storage devices. Computer storage media does not comprise a propagated data signal.

Communication media typically embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above should also be included within the scope of computer-readable media.

Memory 512 includes computer storage media in the form of volatile and/or nonvolatile memory. The memory 512 may be removable, non-removable, or a combination thereof. Exemplary memory includes solid-state memory, hard drives, optical-disc drives, etc. Computing device 500 includes one or more processors 514 that read data from various entities such as bus 510, memory 512, or I/O components 520. Presentation component(s) 516 present data indications to a user or other device. Exemplary presentation components 516 include a display device, speaker, printing component, vibrating component, etc. I/O ports 518 allow computing device 500 to be logically coupled to other devices including I/O components 520, some of which may be built in.

Illustrative I/O components include a microphone, joystick, game pad, satellite dish, scanner, printer, display device, wireless device, a controller (such as a stylus, a keyboard, and a mouse), a natural user interface (NUI), and the like. In embodiments, a pen digitizer (not shown) and accompanying input instrument (also not shown but which may include, by way of example only, a pen or a stylus) are provided in order to digitally capture freehand user input. The connection between the pen digitizer and processor(s) 514 may be direct or via a coupling utilizing a serial port, parallel port, and/or other interface and/or system bus known in the art. Furthermore, the digitizer input component may be a component separated from an output component such as a display device, or in some embodiments, the usable input area of a digitizer may be coextensive with the display area of a display device, integrated with the display device, or may exist as a separate device overlaying or otherwise appended to a display device. Any and all such variations, and any combination thereof, are contemplated to be within the scope of embodiments of the technology described herein.

An NUI processes air gestures, voice, or other physiological inputs generated by a user. Appropriate NUI inputs may be interpreted as ink strokes for presentation in association with the computing device 500. These requests may be transmitted to the appropriate network element for further processing. An NUI implements any combination of speech recognition, touch and stylus recognition, facial recognition, biometric recognition, gesture recognition both on screen and adjacent to the screen, air gestures, head and eye tracking, and touch recognition associated with displays on the computing device 500. The computing device 500 may be equipped with depth cameras, such as stereoscopic camera systems, infrared camera systems, RGB camera systems, and combinations of these, for gesture detection and recognition. Additionally, the computing device 500 may be equipped with accelerometers or gyroscopes that enable detection of motion. The output of the accelerometers or gyroscopes may be provided to the display of the computing device 500 to render immersive augmented reality or virtual reality.

A computing device may include a radio 524. The radio 524 transmits and receives radio communications. The computing device may be a wireless terminal adapted to receive communications and media over various wireless networks. Computing device 500 may communicate via wireless protocols, such as code division multiple access (“CDMA”), global system for mobiles (“GSM”), or time division multiple access (“TDMA”), as well as others, to communicate with other devices. The radio communications may be a short-range connection, a long-range connection, or a combination of both a short-range and a long-range wireless telecommunications connection. When we refer to “short” and “long” types of connections, we do not mean to refer to the spatial relation between two devices. Instead, we are generally referring to short range and long range as different categories, or types, of connections (i.e., a primary connection and a secondary connection). A short-range connection may include a Wi-Fi® connection to a device (e.g., mobile hotspot) that provides access to a wireless communications network, such as a WLAN connection using the 802.11 protocol. A Bluetooth connection to another computing device is a second example of a short-range connection. A long-range connection may include a connection using one or more of CDMA, GPRS, GSM, TDMA, and 802.16 protocols.

### Embodiments

Embodiment 1. An automatic speech recognition (ASR) system comprising: a processor; and computer storage memory having computer-executable instructions stored thereon which, when executed by the processor, implement an acoustic model and a language model: an acoustic sensor configured to convert speech into acoustic information; the acoustic model (AM) comprising a deep neural support vector machine configured to classify the acoustic information into a plurality of phones; and the language model (LM) configured to convert the plurality of phones into plausible word sequences.

Embodiment 2. The system of embodiment 1, wherein the ASR system is deployed on a user device.

Embodiment 3. The system of embodiment 1 or 2, wherein a top layer of the deep neural support vector machine is a multiclass support vector machine, wherein the top layer generates the output of the deep neural support vector machine.

Embodiment 4. The system of embodiment 3, wherein the top layer is trained using a frame-level training.

Embodiment 5. The system of embodiment 1 or 2, wherein a top layer of the deep neural support vector machine is a structured support vector machine, wherein the top layer generates the output of the deep neural support vector machine.

Embodiment 6. The system of embodiment 5, wherein the top layer is trained using a sequence-level training.

Embodiment 7. The system of any of the above embodiments, wherein the number of nodes in the top layer is learned by the SVM training algorithm.

Embodiment 8. The system of any of the above embodiments, wherein the acoustic model and the language model are jointly trained using a sequence-level training.

Embodiment 9. A method for training a deep neural support vector machine (DNSVM) performed by one or more computing devices having a processor and memory, the method comprising: receiving a corpus of training material; determining initial values for parameters of one or more previous layers within the DNSVM; training a top layer of the DNSVM while keeping the initial values fixed using a maximum-margin objective function to find a solution; and assigning initial values to the top layer parameters according to the solution.

Embodiment 10. The method of embodiment 9, wherein the corpus of training material includes one or more labeled acoustic features.

Embodiment 11. The method of embodiment 9 or 10, further comprising: training the previous layers of the DNSVM while keeping the initial values of the top layer parameters fixed using the maximum-margin objective function to generate updated values for parameters of one or more previous layers.

Embodiment 12. The method of embodiment 11, further comprising continuing to iteratively retrain the top layer and the previous layers until parameters change less than a threshold between iterations.

Embodiment 13. The method of any of embodiments 9-12, wherein determining initial values of parameters comprises setting the values of the weights according to a uniform distribution.

Embodiment 14. The method of any of embodiments 9-13, wherein the top layer of the deep neural support vector machine is a multi-class support vector machine, wherein the top layer generates the output of the deep neural support vector machine.

Embodiment 15. The method of embodiment 14, wherein the top layer is trained using a frame-level training.

Embodiment 16. The method of any of embodiments 9-13, wherein the top layer of the deep neural support vector machine is a structured support vector machine, wherein the top layer generates the output of the deep neural support vector machine.

Embodiment 17. The method of embodiment 16, wherein the top layer is trained using a sequence-level training.

Embodiment 18. The method any of embodiments 9-17, wherein the top layer is a support vector machine.

Aspects of the technology described herein have been described to be illustrative rather than restrictive. It will be understood that certain features and subcombinations are of utility and may be employed without reference to other features and subcombinations. This is contemplated by and is within the scope of the claims.

The invention claimed is:

1. An automatic speech recognition (ASR) system comprising:
a processor; and
computer storage memory having computer-executable instructions stored thereon which, when executed by the processor, implement an acoustic model and a language model:
an acoustic sensor configured to convert speech into acoustic information;
the acoustic model (AM) comprising a deep neural support vector machine configured to classify the acoustic information into a plurality of phones; and
the language model (LM) configured to convert the plurality of phones into plausible word sequences.

2. The system of claim 1, wherein the ASR system is deployed on a user device.

3. The system of claim 1, wherein a top layer of the deep neural support vector machine is a multi-class support vector machine, wherein the top layer generates the output of the deep neural support vector machine.

4. The system of claim 3, wherein the top layer is trained using a frame-level training.

5. The system of claim 1, wherein a top layer of the deep neural support vector machine is a structured support vector machine, wherein the top layer generates the output of the deep neural support vector machine.

6. The system of claim 5, wherein the top layer is trained using a sequence-level training.

7. The system of claim 1, wherein the number of nodes in the top layer is learned by the SVM training algorithm.

8. The system of claim 1, wherein the acoustic model and the language model are jointly trained using a sequence-level training.

9. A method for training a deep neural support vector machine (DNSVM) performed by one or more computing devices having a processor and memory, the method comprising:
receiving a corpus of training material;
determining initial values for parameters of one or more previous layers within the DNSVM;
training a top layer of the DNSVM while keeping the initial values fixed using a maximum-margin objective function to find a solution; and
assigning initial values to the top layer parameters according to the solution.

10. The method of claim 9, wherein the corpus of training material includes one or more labeled acoustic features.

11. The method of claim 9, further comprising:
training the previous layers of the DNSVM while keeping the initial values of the top layer parameters fixed using the maximum-margin objective function to generate updated values for parameters of one or more previous layers.

12. The method of claim 11, further comprising continuing to iteratively retrain the top layer and the previous layers until parameters change less than a threshold between iterations.

13. The method of claim 9, wherein determining initial values of parameters comprises setting the values of the weights according to a uniform distribution.

14. The method of claim 9, wherein the top layer of the deep neural support vector machine is a multi-class support vector machine, wherein the top layer generates the output of the deep neural support vector machine.

15. The method of claim 14, wherein the top layer is trained using a frame-level training.

16. The method of claim 9, wherein the top layer of the deep neural support vector machine is a structured support vector machine, wherein the top layer generates the output of the deep neural support vector machine.

17. The method of claim 16, wherein the top layer is trained using a sequence-level training.

18. The method of claim 11, wherein the top layer is a support vector machine.

19. One or more computer-storage media comprising computer executable instructions that, when executed by a processor perform a method for training a deep neural support vector machine (DNSVM) performed by one or more computing devices having a processor and memory, the method comprising:
receiving a corpus of training material, wherein the corpus of training material includes one or more labeled acoustic features.;
determining initial values for parameters of one or more previous layers within the DNSVM;
training a top layer of the DNSVM while keeping the initial values fixed using a maximum-margin objective function to find a solution;
assigning initial values to the top layer parameters according to the solution; and
training the previous layers of the DNSVM while keeping the initial values of the top layer parameters fixed using the maximum-margin objective function to generate updated values for parameters of one or more previous layers.

20. The media of claim 11, wherein the top layer is a support vector machine.
